(19) United States
(12) Patent Application Publication
(10) Pub. No.: US 2022/0278406 A1
(43) Pub. Date: Sep. 1, 2022

(54) BATTERY HOLDER FOR TIERED BATTERY PACKS

(71) Applicant: COMPAGNIE GENERALE DES ETABLISSEMENTS MICHELIN, Clermont-Ferrand (FR)

(72) Inventors: BRUNO FRAGNIERE, Clermont-Ferrand (FR); DANIEL WALSER, Clermont-Ferrand (FR)

(21) Appl. No.: 17/627,978

(22) PCT Filed: Jul. 16, 2020
(86) PCT No.: PCT/FR2020/051284

§ 371 Date: Jan. 18, 2022

(30) Foreign Application Priority Data
Jul. 18, 2019 (FR) FR1908139

(51) Int. Cl. H01M 50/213; H01M 50/262; H01M 50/503; H01M 10/613; H01M 10/643; H01M 50/516

(52) U.S. Cl. CPC H01M 50/213; H01M 50/262; H01M 50/503; H01M 10/613; H01M 10/643; H01M 50/516

(57) ABSTRACT

A battery holder (10) includes a support plate having at least two adjacent through-holes (2a, 2b; 4a, 4b; 6a, 6b; 8a, 8b), each hole being capable of receiving, in the case of one hole, the end including the terminal (14a) of a first battery (12) and, in the case of the other hole, the end including the terminal (14b) of a second battery (12), together with a connection element (4, 40) coming into contact with the terminals of the batteries, which it connects electrically. The plate comprises two portions (10a, 10b) forming a movable assembly so as to change from an unfolded position in which the two portions (10a, 10b) are positioned side by side in the same plane, to a folded position in which the two portions are positioned one on top of the other, the connection element (4, 40) connecting the terminals (14a, 14b) in both positions.

The present invention relates to the field of battery systems for mobile systems, such as vehicles, or for stationary storage, particularly of the type including an arrangement of several batteries forming a tiered battery pack.

A battery pack is itself usually made up of a plurality of individual batteries connected to each other. These batteries can have various geometric shapes, such as prismatic, pouch or cylindrical. They are electrically connected according to the requirements of the application, forming a combination of batteries in series and in parallel. To this end, it must be possible to connect their poles by means of a conductive element, which can for example be screwed or soldered to their terminals. For some applications in which the current passing through the batteries is low, there can be stacks of batteries that are not rigidly connected to each other, but simply in contact (such as in a portable radio set). For most applications, however, when a strong current and/or high voltage is/are necessary, the batteries must be rigidly connected to each other by means of a conductive element. This is all the more necessary for applications in which the pack will be subject to vibrations or accelerations, as is the case for a vehicle battery pack.

The most frequently used cylindrical batteries are 18650 batteries (diameter 18 mm, length 65 mm), but 21700 batteries also exist, for example (diameter 21 mm, length 70 mm). In order to produce an assembly of such cylindrical batteries, they must first be positioned vertically next to each other in an arrangement of rows and columns. To this end, rigid holders exist, made from electrically non-conductive materials, with the appearance of a plate with holes for receiving the batteries. One such holder can be placed underneath and another on top of the batteries, and they can then be electrically connected, for example by soldering a band of nickel to the battery terminals. Once the connection has been made, this unit holds together mechanically and makes it possible to handle the batteries supported as a single assembly. Depending on the number of batteries in parallel and in series, an arrangement will thus be obtained that is usually parallelepipedal with a height equivalent to the height of an individual battery.

EP 2 008 354 discloses another way of connecting the batteries in such an arrangement to each other, namely soldering small metal wires connecting one terminal of the battery to a conductive band belonging to one of the holders of the arrangement. This type of connection makes it possible to isolate a faulty battery from the system, as the small metal wire in question acts as a fuse. Due to the multiple solders, this way of connecting the batteries of a battery pack does however have a high manufacturing cost.

Another solution is known from EP 0 905 803, which describes a battery arrangement or pack held between two parallel holders each provided with through-holes making it possible to hold the batteries in place, in which a hole of one row is connected to the hole of the adjacent row of the same holder by a groove made in the holder. An electrical connector is positioned in the groove and screwed to the terminals of the batteries, thus connecting them to each other. Ventilation holes are also made in the holder in order to allow the cooling of the batteries. Several packs with multiple rows of batteries can be connected laterally. This solution, which requires an operation using screws and nuts to fasten each connector connecting two batteries to each other, is painstaking and increases the cost of the pack. In addition, it is not suitable for tiered mounting of the batteries.

If, for reasons of footprint, the user wishes not to be restricted to a single height of batteries, but wishes to have a double height for example, there is no choice other than to stack arrangements as produced above, and then connect them to each other subsequently, for example with an electric cable.

One aim of the invention is to overcome the drawbacks of the battery arrangements described in the aforementioned documents and propose a battery arrangement over several tiers (at least two), making it possible to partially or completely eliminate the need to connect the tiers of batteries to each other after stacking.

This aim is achieved by the invention, which proposes a battery holder including a support plate in the thickness of which are made at least two adjacent through-holes, each hole being capable of receiving, in the case of one hole, the end including the terminal of a first battery and, in the case of the other hole, the end including the terminal of a second battery, together with a connection element coming into contact with the terminals of said batteries, which it connects electrically, characterized in that said plate comprises two portions forming a movable assembly so as to change from an unfolded position in which the two portions are positioned side by side in the same plane, to a folded position in which the two portions are positioned one on top of the other, the connection element connecting the terminals of the batteries in the unfolded position and in the folded position.

In other words, the invention proposes a battery holder making it possible to change easily from the unfolded position of the holder, which corresponds to the position in which the batteries are assembled with said holder, to a folded position of the holder in which the batteries continue on from each other while being electrically connected, thus forming a tiered battery assembly. Battery holder is given to mean a unit forming a holder for electric batteries and including a plate for supporting the batteries, the role of which is to hold them in position in the holder, and an electrical connection element, the role of which is to electrically connect the terminals of the batteries to each other. The holder of the invention incorporates an electrical connection element from the outset, that is, as soon as the batteries are mounted, which connection is made robust, for example by soldering a conductive element to the terminals of the batteries, thus ensuring the electrical connection thereof. An electrical connection is therefore maintained when the holder is folded, the conductive element folding with the holder and thus ensuring the continuity of the connection on the tiered stacking of the batteries. Two tiers can be formed, but this can be more if necessary.

The electrical connection made in the holder of the invention can electrically connect the terminals of the two batteries in series when the connection element connects the negative terminal of a first battery to the negative terminal of the second battery, or in parallel when the connection element connects together the terminals with the same polarity of the two adjacent batteries.

The upper face of the plate can extend in a plane P, said portions can be delimited by a mid-plane M passing between said holes and perpendicular to the plane P, said two portions being able to be movable about an axis of rotation parallel to the plane P and contained in the plane M.

Said two portions can be separated by a foldable hinge made from the same material as the plate of the holder.

The connection element can fold at the same time as the other portions of the holder during the transition from the unfolded position to the folded position.

The plate can comprise, on its upper face, recesses positioned on the edge of said holes, forming stops for the batteries.

The plate can comprise means for locking the two portions to each other in the folded position.

The plate can comprise a groove for receiving the connection element.

The lateral edge of said plate can comprise at least one channel with a longitudinal axis perpendicular to the plane P.

The plate can include, at the ends thereof, members for assembly with an adjacent holder.

Each plate portion can comprise a series of at least two holes, the holes of a series of one plate portion being positioned facing the holes of the series of the second plate portion and the connection element can be a connection bus connecting the different holes to each other.

The aim of the invention is also achieved with a battery pack including a battery holder according to the invention and at least two batteries connected by the connection element of the holder.

The battery pack can comprise an even number of battery tiers.

Two battery packs can be connected to each other using an electrically conductive band positioned at the ends of the batteries opposite those held by the holder.

The battery pack can comprise an odd number of battery tiers.

Two battery packs in the folded position can be connected to each other at the free ends using an electrically conductive member.

The electrically conductive member can include a central portion connected by articulations to two end portions.

The battery pack can comprise a cooling module in thermal contact with the batteries held by a holder in the folded position. The invention further makes it possible to incorporate, while the previously electrically connected assembly is unfolded and into the battery pack thus formed, efficient cooling technology based on heat-conducting tubes inserted between the batteries, without having to make additional electrical connections.

The invention also relates to a method for assembling a tiered battery pack, characterized in that it includes the following steps:

positioning at least two batteries vertically next to each other by inserting the end including the terminal of a first battery and the end including the terminal of a second battery into a holder according to the invention;
positioning a connection element on the plate of the holder by bringing it into contact with the terminals of said batteries;
soldering said connection element onto the terminals of said batteries;
folding said holder so as to obtain the tiered battery pack.

The invention will be better understood from the rest of the description, which is supported by the following figures:

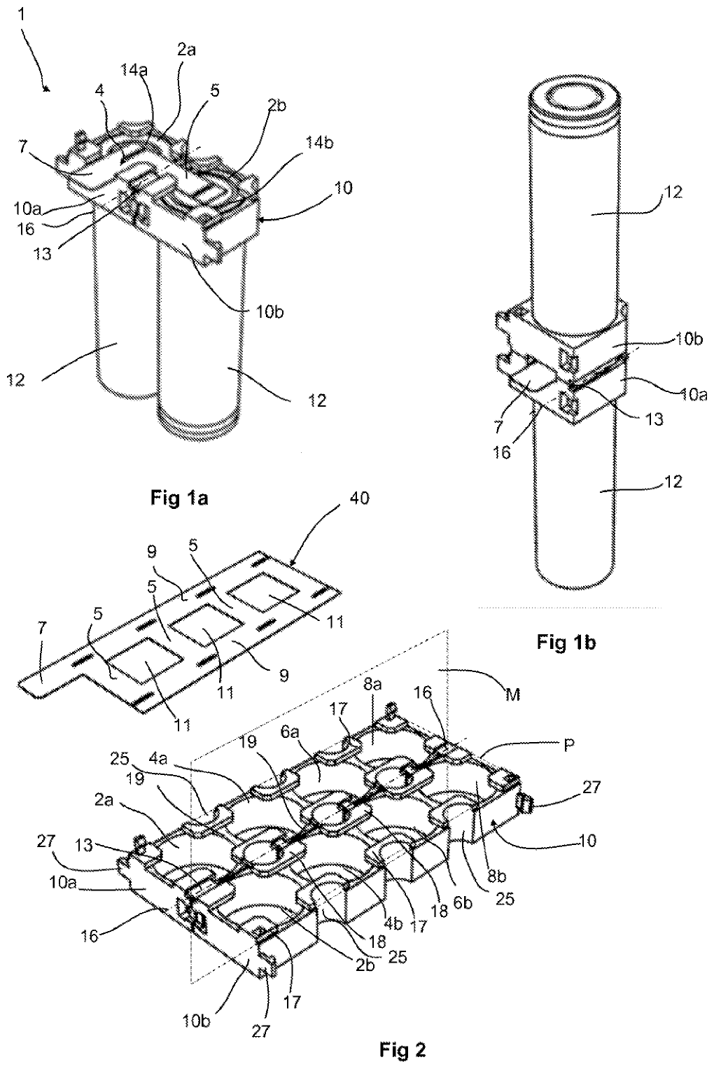

FIG. 1a is a perspective view of a pack including two batteries mounted in a holder of the invention in the unfolded position, and FIG. 1b illustrates the same pack in which the batteries are tiered, the holder being in the folded position;

FIG. 2 is an exploded perspective view of the holder of the invention in a variant embodiment;

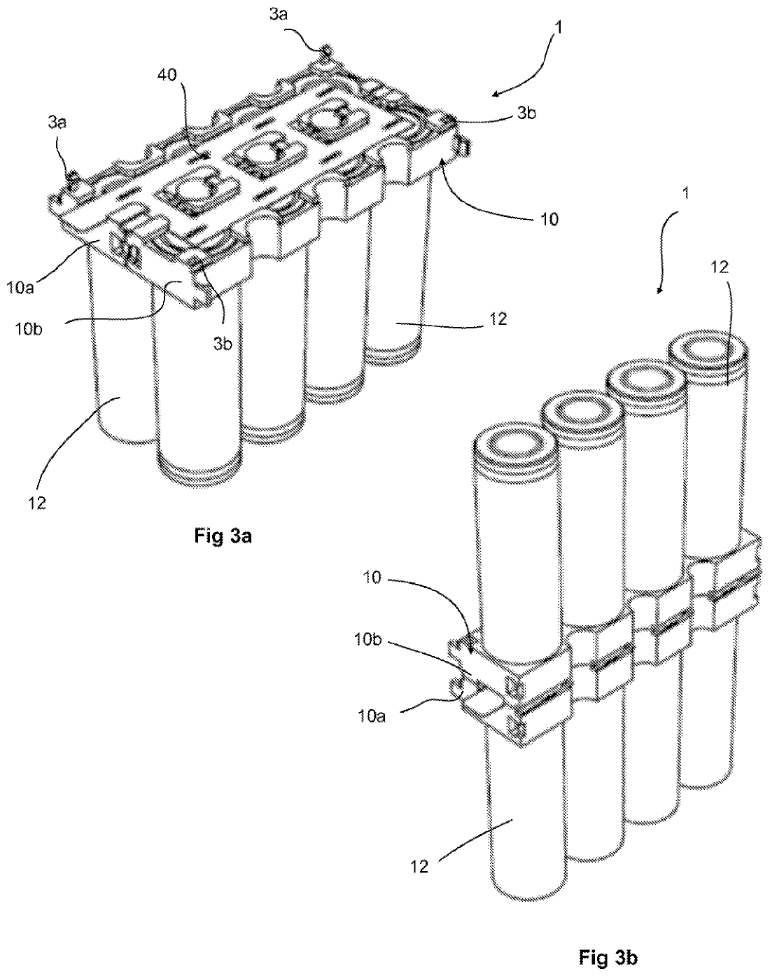

FIG. 3a is a perspective view of a battery pack using the holder illustrated in FIG. 2, and FIG. 3b illustrates the pack illustrated in FIG. 3a with the batteries tiered, the holder being in the folded position;

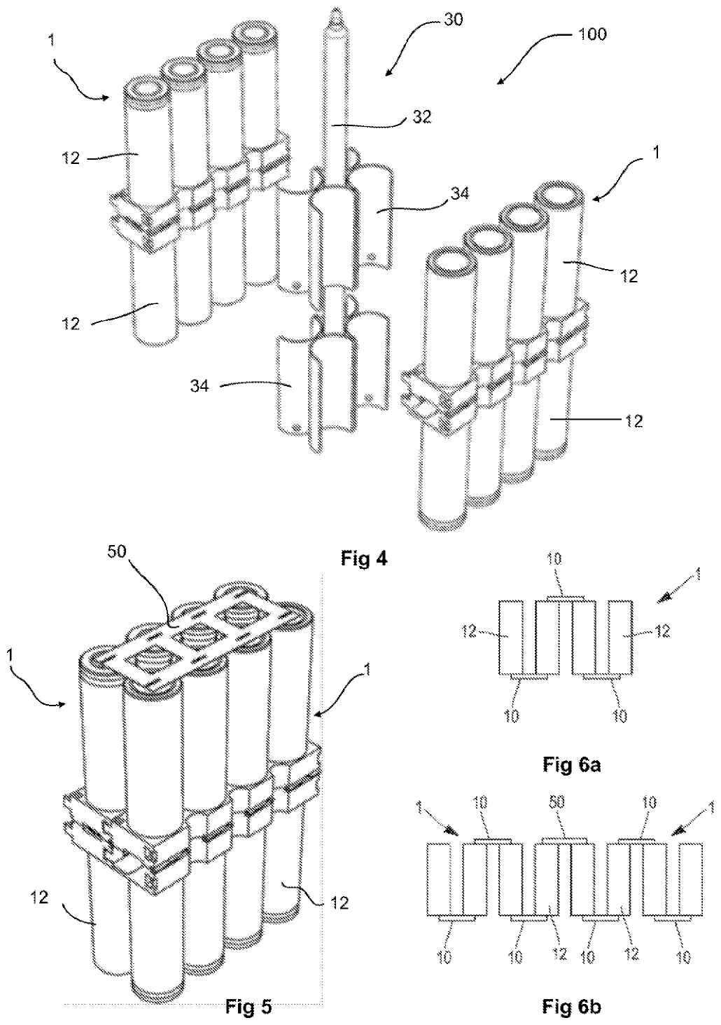

FIG. 4 is an exploded perspective view of another variant embodiment of the invention;

FIG. 5 is a perspective view of a tiered battery pack according to another variant of the invention in which two previously folded battery packs are electrically connected to each other;

FIGS. 6a and 6b schematically illustrate the way in which two battery packs can be connected to each other according to one variant of the invention;

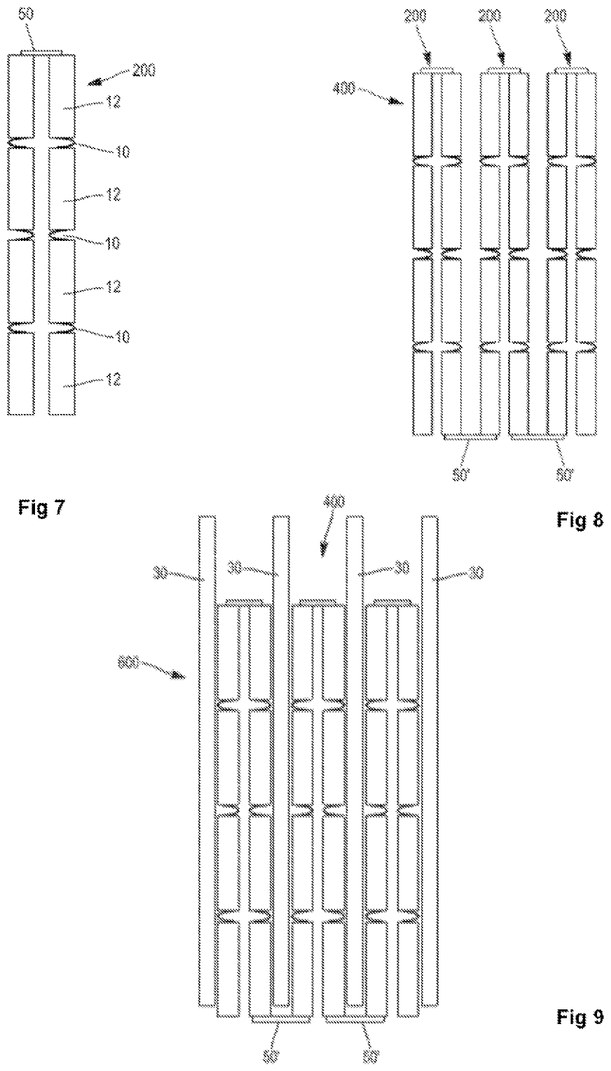

FIG. 7 is a schematic view of a battery pack according to the variant illustrated in FIG. 6b in folded mode;

FIG. 8 is a schematic view illustrating an example of the connection of several battery packs as illustrated in FIG. 7;

FIG. 9 is a schematic view of a preferred embodiment of the battery pack illustrated in FIG. 8, incorporating heat tubes;

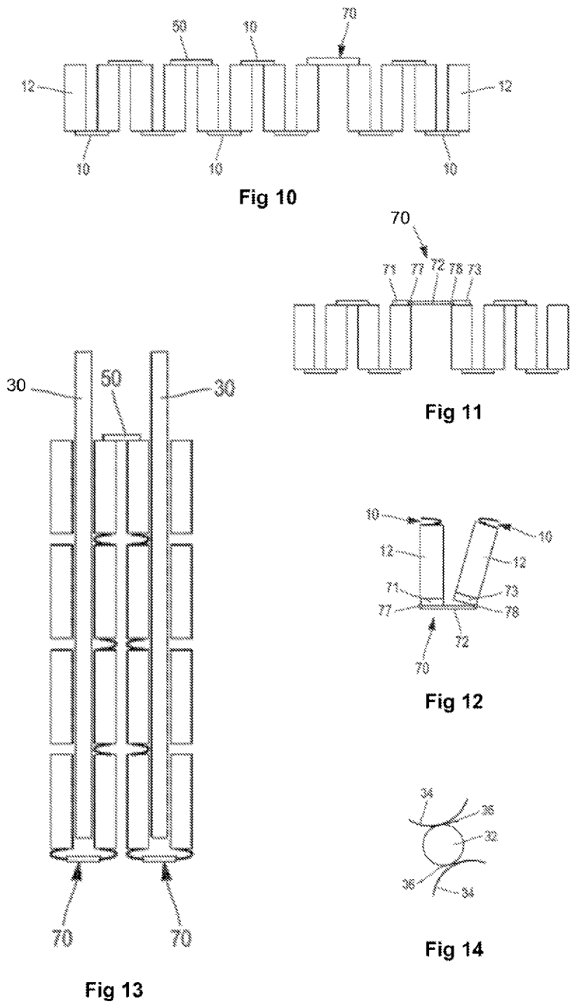

FIG. 10 is a schematic view of another variant embodiment of the invention;

FIGS. 11 and 12 are schematic views of certain embodiment details of the pack illustrated in FIG. 10;

FIG. 13 is a preferred variant embodiment of the pack illustrated in FIG. 10, illustrated here in the folded position;

FIG. 14 illustrates an embodiment detail of the attachment of the heat collector to the heat tube used in a battery pack;

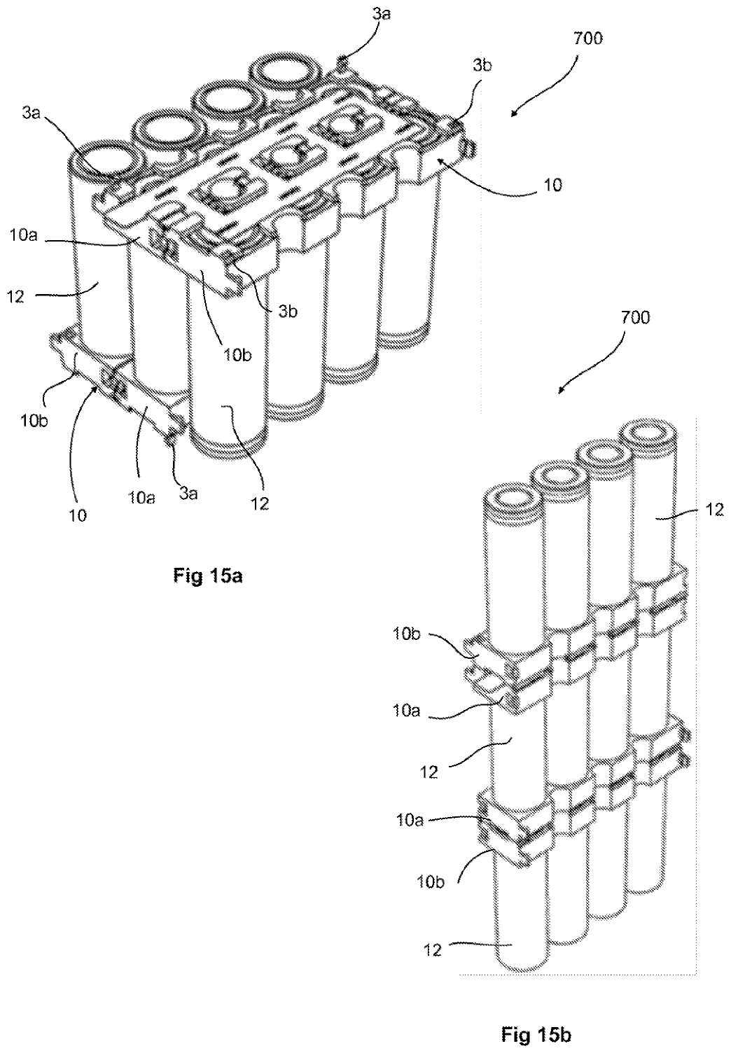

FIGS. 15a and 15b are perspective views of a battery pack using two holders as illustrated in FIG. 2, the pack being illustrated in the assembly position and in the tiered position of the batteries.

In the various figures, elements that are identical or similar have the same reference signs. Their description is therefore not systematically repeated.

FIG. 1a illustrates a battery holder 10 produced in the form of a plate in the thickness of which two adjacent through-holes 2a, 2b are made. The plate is for example made by moulding or injection of a plastic material of the styrenic polymer type, such as ABS (acrylonitrile butadiene styrene), which is an electrically insulating and fire retardant material. FIG. 1a also shows two cylindrical batteries 12 held vertically in place by the holder 10, each battery 12 being inserted with one of its ends in each hole 2a, 2b of the holder 10, the longitudinal axis of each battery 12 being perpendicular to the plane P of the plate (FIG. 2). The holder 10 further includes a connection element 4 that is a metal sheet, for example nickel or copper, coming into contact with the electrical terminals of the batteries 12, this contact preferably being made by soldering the metal sheet to the terminals of the batteries. In the example illustrated in FIG. 1a, one of the batteries is mounted with its positive terminal 14a in the hole 2a, and the other with its negative terminal 14b in the hole 2b, the connection element 4 thus producing a series connection of the two batteries. In the example illustrated in FIG. 1a, the connection element 4 is an L-shaped metal sheet, the long side of the L forming a transverse strip 5 connecting the terminals of the batteries to each other and the short side forming a tab 7 protruding outside the holder 10, making it possible to form a voltage tap, for example. In another example, the batteries are positioned in the holder so that the two terminals 14a and 14b have the same polarity, connected in parallel by the connection element 4.

FIG. 2 illustrates a holder 10 according to a variant embodiment of the invention, the holder being made in the form of a plate, as in the previous example, but having a larger surface than the plate of the previous example, thus making it possible to receive eight through-holes 2a, 2b, 4a, 4b, 6a, 6b, 8a, 8b, which are made in the thickness thereof. The first quarter of the surface of the holder 10 including the holes 2a and 2b is identical to the surface of the holder 10 in FIG. 1a. The holes 2a to 8b have a circular cross-section and a constant diameter in the thickness of the plate and a dimension making it possible to receive the end 14 of a battery with sliding clearance. Each of the holes 2a to 8b comprises recesses 17 on its perimeter, four in number for each hole, which recesses extend in the plane P of the holder 10 and form axial stops for the batteries 12. The recesses 17 of four neighbouring holes 2a, 2b, 4a, 4b form an island 18 slightly protruding vertically relative to the front wall of each hole, which thus makes it possible to form, with the wall and a neighbouring island 18, a groove 19 for receiving an electrically conductive element for establishing a connection, for example a transverse strip 5. As can be seen in FIG. 2, half of an island 18 is present between two neighbouring holes, for example 2a, 4a, which makes it possible to form a groove 19 with the front wall of the holes 2a, 4a and thus hold in position an electrically conductive element in order to establish a connection between the batteries, for example a longitudinal strip 9 of the connection element 40.

More particularly with reference to FIG. 2, the connection element 40 will be noted, being a generally rectangular metal sheet, with a thickness of less than 1 mm, made from nickel or copper and in which three rectangular openings 11 are cut out. The connection element 40 thus formed has two parallel longitudinal strips 9 connected by four transverse strips 5, a tab 7 also being provided at one end of the connection element 40 to form a voltage tap. The islands 18 of the holder 10 pass through the openings 11 of the connection element and make it possible to hold it in place and in the correct position, so that the connection element 40 can be soldered to the terminals of the batteries 12 quickly.

According to the invention, said plate of the holder 10 is made in two portions 10a, 10b delimited by a mid-plane M passing between said holes 2a, 2b equidistant from the centres thereof and perpendicular to the plane P of the plate, and the two portions 10a, 10b form a movable assembly so as to change from an unfolded position (FIG. 1a) in which the two portions 10a, 10b are positioned side by side in the same plane, to a folded position (FIG. 1b) in which the two portions 10a, 10b are one on top of the other. In the example in the appended figures, the portions 10a, 10b are movable about an axis of rotation 16 parallel to the plane P and contained in the plane M. The axis of rotation 16 is embodied by the mid-portion of a flexible hinge 13 preferably forming part of the holder 10 and made from the same material as the plate of the holder 10. Said material of the holder 10 is also required to be capable of having a join or hinge in the middle thereof, between the portions 10a, 10b, such that the part can be folded on itself without breaking.

The connection element folds at the same time as the other portions of the holder during the transition from the unfolded position to the folded position. The connection element 4 is preferably a flexible sheet, having the same capacity to fold (as it is subject to the same movement imparted) as the hinge of the plate of the holder 10 and thus following the folding movement of the holder 10 between the two positions, while providing the connection in the unfolded position and in the folded position.

With reference to FIG. 3a, it will be observed that the holder 10 additionally has means for locking the two portions to each other in the folded position, for example hooks 3a protruding vertically from the portion 10a of the plate of the holder and interacting with retaining holes 3b having a complementary shape made in the portion 10b of the plate of the holder 10.

The holder 10 has, on its lateral edge, in particular on the longitudinal sides thereof, several generally semi-cylindrical channels 25 having a longitudinal axis perpendicular to the plane P. As can be seen more clearly in FIG. 2, the channels 25 are made in the wall of the holder 10 separating two holes, for example 2b and 4b, 2a and 4a respectively. The channels 25 serve for the cooling of the batteries, for example by installing cooling tubes in the channels 25, as will be explained below.

The plate of the holder 10 also includes means 27 for assembly with the plate of an adjacent holder 10, which makes it possible to produce an assembly of tiered batteries in the form of a modular structure, on the basis of a holder 10 of the invention.

The method for assembling a tiered battery pack 1 as illustrated in FIGS. 1a and 1b comprises the following steps:

positioning at least two batteries 12 vertically next to each other by inserting the end including the positive terminal of a first battery 12 and the end including the negative terminal of a second battery 12 into the holes 2a, 2b of the holder 10;
positioning an electrically conductive connection element 4 on the plate of the holder 10 by bringing it into contact with the terminals of said batteries;
soldering said connection element 4 onto the terminals of the batteries 12, which soldering can be resistance soldering or soldering using an external laser heat source; in the latter case, additional pressure must ensure contact before soldering;
folding said holder 10 so as to stack the two portions 10a, 10b of the holder 10 together with the connection element 4 to obtain the tiered battery pack 1.

FIGS. 1a and 1b illustrate the connection mode for the smallest possible entity, with two batteries 12 in series. According to the invention, these two batteries 12 are firstly positioned vertically next to each other with the opposite pole of each battery in the same horizontal plane. The two batteries 12 are capped by the plate of the holder 10, which holds them in place, and are electrically connected by the connection element 4. Next, the two portions 10a and 10b of the holder 10 are pivoted relative to each other about the axis 16 of the hinge 13, the flexibility of the metal sheet of the connection element 4 allowing the movement, and one battery can be turned over on top of the other to obtain a two-tiered battery pack 1 arrangement, as can be seen in FIG. 1b. The new position of the tiered battery pack arrangement is locked by means of the hooks 3a and the corresponding receiving holes 3b forming a complementary shape.

The proposed connection mode makes it possible to construct a battery pack 1 by connecting the batteries 12 in series and parallel, it being possible to envisage different combinations of series and parallel connection of batteries. FIGS. 3a and 3b thus illustrate another variant of the invention in which the battery pack 1 has a more complex architecture. In this configuration there are eight batteries and two arrangements of four batteries connected in parallel are placed in series. The two hooks 3a can be seen, situated in two corners of the plate of the holder 10, making it possible to lock the unit forming the tiered battery pack once the folding operation has been performed. The example described here places in series two rows of four batteries connected to each other in parallel with an eight-hole support plate, but of course a sixteen-hole plate can be envisaged for example, generally square and provided with a folding axis in the middle thereof, making it possible to place in series two rows of eight batteries connected to each other in parallel.

FIG. 4 illustrates another variant embodiment of the invention showing a unit 100 produced by the combination of a tiered battery pack 1 assembly of the invention with cooling modules 30. In a preferred embodiment, the cooling modules 30 each comprise a heat-pipe the operation of which is based on the principle of expelling heat through heat tubes 32 provided with thermal collectors 34 made from a thermally conductive material (for example aluminium) partially encasing the cylindrical batteries 12 with which they are in contact. The heat tubes 32 contain a fluid that vaporizes at the point where they are in contact with the collectors 34 under the effect of the heat of the battery emitted during the operation thereof. The vapour fills the tube and condenses at the point where the temperature is lower than the condensation temperature. The condensate then falls by gravity to the bottom of the tube, level with the batteries 12. The heat exchanged originates from the latent heat linked to the phase changes. A colder point can be obtained on the tube due to the environment (for example atmospheric air) or due to a heat dissipating element (for example fins, not illustrated in the drawings) on the upper portion of the tube 32. The heat tubes 32 are preferably arranged vertically in order to benefit fully from the effect of gravity. In the example illustrated in FIG. 4, each tiered battery pack 1 uses eight batteries 12, and the cooled battery pack unit therefore comprises two tiered battery packs 1 each having eight batteries and a cooling module 30 having a heat tube 32 longer than the two tiers of batteries, collectors 34 being provided on each tier.

In a variant not illustrated in the drawings, the heat-pipes can be replaced by simple tubes made from a thermally conductive material and inside which flows a forced air stream, for example an air stream upstream of the suction of the compressor of a fuel cell coupled to battery packs of the invention. In another variant (not illustrated) the tubes are connected to a cooling circuit of the type including a pump and a coolant reservoir.

In another variant, the two battery packs 1 can further be electrically connected, this being done by turning the unit 100 over in order to have access to the terminals of the batteries 12. This variant, showing the electrical connections of the two battery packs 1, is illustrated in FIG. 5, the cooling module being omitted for greater clarity. The terminals of the batteries 12 of the two tiered battery packs 1 are thus connected to each other by an electrically conductive band 50. The electrically conductive band 50 is a metal sheet including longitudinal and transverse strips making it possible to electrically connect the terminals of the eight batteries to each other.

In other variants of the invention, tiered battery packs can be produced having an even number (greater than or equal to two) or an odd number (greater than or equal to three) of tiers. The manner in which such complex battery packs are constructed is explained below.

FIGS. 6a, 6b, 7, 8, 9, 10 and 13 illustrate battery packs with even numbers of tiers, having more than two tiers. In order to produce such a battery pack with even numbers of tiers, having more than two tiers, the terminals of the batteries are firstly electrically connected, in a similar manner to that shown in FIG. 5, but before the movable parts of the holder 10 are folded. More particularly, FIG. 6a schematically shows a battery pack 1 in the step of assembling the batteries 12 in the holder 10, before folding the movable portions thereof. Such an embodiment makes it possible to obtain, directly after folding, the arrangement visible in FIG. 5, therefore without having to additionally further electrically connect the two tiers of batteries juxtaposed against each other. The batteries in FIG. 6a are connected to each other by holders 10. By connecting two battery packs 1 in FIG. 6a to each other using an electrically conductive band 50, the unit shown in FIG. 6b is obtained. Next, by folding the movable portions of each holder 10, a single tiered battery pack 200 is obtained, as shown in FIG. 7. Next, by associating several single tiered battery packs 200 and electrically connecting them to each other having first turned them over in order to make the electrical connections of the terminals of the batteries using an electrically conductive band 50′, a unit 400 of several single packs is obtained, illustrated in FIG. 8.

FIG. 9 illustrates an improved unit comprising cooling modules 30 inserted between the various single battery packs 200.

It will be understood that by positioning the batteries in a single tier in order to connect them as proposed, a limitation occurs on the number of tiers possible after unfolding. In the absence of one electrical connection differing from the others, it will not be possible to unfold the assembly if the desired number of tiers is even, due to the direction in which the assembly must naturally be extended. In such a case, if the user nonetheless wishes to be able to proceed in the same way, this must be made possible through the use of an electrically conductive member 70 with a specific structure, which is longer and has a double fold line about articulations 77, 78 so that the unfolded unit can return to the compact architecture described above and reproduced below to make it possible to visualize the deformation mode of the specific connecting part (FIGS. 10 to 12). With such an arrangement, the preferred situation is that of even distribution of the cooling modules 30 in the rows of batteries, as shown in FIG. 13.

In particular, it makes it possible, through the elasticity of the electrically conductive member 70, to ensure a certain degree of prestressing in the contact between the batteries and the heat tubes, which prestressing promotes satisfactory heat exchange. FIG. 13 illustrates a tiered battery pack unit including two packs each having four tiers of batteries enclosing cooling modules 30. On assembling this unit, the heat tubes 32 of the cooling module 30 are inserted by separating the tiered packs connected at the base by the electrically conductive member 70. Once the unit has been assembled and closed, the electrically conductive members maintain satisfactory thermal contact between the heat tubes and the batteries of the unit.

The cooling performance (if all of the tiered battery packs comprise cooling modules with heat tubes) will of course depend on the design, but also the capacity of the assembly to ensure satisfactory thermal contact between the individual batteries and the heat collectors attached to the heat tubes. To this end, in the variant illustrated in FIG. 14, structural solutions providing elasticity in the thermal contact can be envisaged. This can be done through the heat collectors, which rest via elastic fins 36 made from a thermally conductive material on the heat tubes 32. Alternatively, these fins can be incorporated into the battery holder parts to ensure prestressing in the contact between the batteries 12 and the heat collectors 34.

It will be noted that, if the number of battery tiers desired is uneven, it will not be necessary to use a specific connection, as shown in FIGS. 15a and 15b. FIG. 15a illustrates a unit 700 including three tiers in the unfolded position and FIG. 15b illustrates the unit 700 after folding of the movable parts of the holders 10. Cooling modules 30 can of course be inserted between the various rows of tiered batteries as described above.

The invention also makes it possible to very simply produce a package including several tiered battery packs the general shape of which is not a simple parallelepiped. This is applicable for example in the automotive field, where a battery package has a given thickness over a certain area (under the passengers' feet) but has two or three tiers elsewhere (under the passenger seats). In this case, the invention makes it possible to propose an elegant, robust package having, for example, a three-tier pack adjacent to a single-tier pack or a two-tier pack adjacent to a single-tier pack extended by another single-tier pack which is in turn adjacent to another two-tier pack.

Other variants and embodiments of the invention can be envisaged within the scope of the invention as claimed. A connection using a fuse element between each battery and the connection element of the holder can thus be provided so that a defective battery can be isolated in a battery pack of the invention. In one variant, the use of the holder of the invention with prismatic batteries can be envisaged.

1.-15. (canceled)

16. A battery holder including:
a support plate in a thickness of which are made at least two adjacent through-holes, each through-hole being capable of receiving, in the case of one hole, an end including a terminal of a first battery and, in the case of another hole, an end including a terminal of a second battery; and
a connection element in contact with the terminals of the first and second batteries, the connection element connecting the first and second batteries electrically,
wherein the plate comprises two portions forming a movable assembly so as to change from an unfolded position in which the two portions are positioned side by side in a same plane to a folded position in which the two portions are positioned one on top of the other, the connection element connecting the terminals of the first and second batteries in the unfolded position and in the folded position.

17. The battery according to claim 16, wherein an upper face of the plate extends in a plane P, the two portions being delimited by a mid-plane M passing between the at least two through-holes and perpendicular to the plane P, the two portions being movable about an axis of rotation parallel to the plane P and contained in the mid-plane M.

18. The battery according to claim 16, wherein the two portions are separated by a foldable hinge made from a same material as the plate.

19. The battery according to claim 16, wherein the connection element folds at the same time as a remainder of the holder during transition from the unfolded position to the folded position.

20. The battery according to claim 16, wherein the plate comprises means for locking the two portions to each other in the folded position.

21. The battery according to claim 16, wherein the plate includes, at the ends thereof, members for assembly with an adjacent holder.

22. The battery according to claim 16, wherein each plate portion comprises a series of at least two through-holes, the holes of a series of one plate portion being positioned facing the holes of a series of the second plate portion, and the connection element is a connection bus connecting holes to each other.

23. A battery pack including the battery holder according to claim 16 and at least two batteries connected by the connection element of the battery holder.

24. The battery pack according to claim 23, wherein the batter pack comprises an even number of tiers of batteries.

25. The battery pack according to claim 24, wherein two battery packs are connected to each other using an electrically conductive band positioned at the ends of the batteries opposite the ends held by the holder.

26. The battery pack according to claim 23, wherein the battery pack comprises an odd number of tiers of batteries.

27. The battery pack according to claim 23, wherein two battery packs in the folded position are connected to each other at the free ends thereof using an electrically conductive member.

28. The battery pack according to claim 27, wherein the electrically conductive member includes a central portion connected by articulations to two end portions.

29. The battery pack according to claim 23, wherein the battery pack comprises a cooling module in thermal contact with batteries held by a holder in the folded position.

30. A method for assembling a tiered battery pack, the method comprising the steps:
positioning at least two batteries vertically next to each other by inserting the end including the terminal of the first battery and the end including the terminal of the second battery into the battery holder according to claim 16;
positioning the connection element on the holder by bringing it into contact with the terminals of the batteries;
soldering the connection element onto the terminals of the batteries; and
folding the holder so as to obtain the tiered battery pack.
